(19) United States
(12) Patent Application Publication
(10) Pub. No.: US 2026/0298268 A1
(43) Pub. Date: Oct. 1, 2026

(54) POSITIVE-FEEDBACK STEADY-STATE FLOW FORCE STRUCTURE FOR SPOOL

(71) Applicant: ZHEJIANG UNIVERSITY, Hangzhou (CN)

(72) Inventors: Qi SU, Hangzhou (CN); Hanfeng ZHANG, Hangzhou (CN); Zhi QIU, Hangzhou (CN); Bing XU, Hangzhou (CN); Junhui ZHANG, Hangzhou (CN)

(73) Assignee: ZHEJIANG UNIVERSITY, Hangzhou (CN)

(21) Appl. No.: 19/686,857

(22) Filed: May 25, 2026

(30) Foreign Application Priority Data
Mar. 27, 2025 (CN) 202510370791.5

(51) Int. Cl. F15B 13/04

(52) U.S. Cl. CPC F15B 13/0402

(57) ABSTRACT

The provided is a positive-feedback steady-state flow force structure for a spool. Two sets of symmetric frustoconical structures are respectively disposed on two ends of the spool, and a plurality of oil holes are formed in a sleeve, thereby forming the positive-feedback steady-state flow force structure; the spool cooperates with the sleeve to generate a vortex during movement; and fluid at different flow velocities in a same flow chamber generates different thrusts on a wall of the flow chamber, thereby obtaining a positive-feedback flow force that facilitates the movement of the spool. The spool provided with the positive-feedback steady-state flow force structure can reduce the resistance characteristics of the flow force, can prevent power saturation of the original structure at steady-state high-pressure and high-flow points, and can allow the spool to operate in a certain combined flow rate-pressure condition, expanding the power limit of the valve.

### CROSS-REFERENCE TO THE RELATED APPLICATIONS

This application is based upon and claims priority to Chinese Patent Application No. 202510370791.5, filed on Mar. 27, 2025, the entire contents of which are incorporated herein by reference.

### TECHNICAL FIELD

The present disclosure relates to the technical field of hydraulic control systems, and large-scale equipment manufacturing and engineering machinery, and in particular, to a positive-feedback steady-state flow force structure for a spool.

### BACKGROUND

Selection of hydraulic valves is a critical link. This process is typically based on the flow demand and dynamic response characteristics of the system. However, various existing hydraulic valves have different power limits. The power limits impose significant restrictions on steady-state flow rates and dynamic responses of the valves, and power in many special application scenarios is limited. Hydraulic systems with high power limits are applied to many fields. For example, in the field of new energy vehicle manufacturing, requirements on system performance of automotive integrated sheet metal die-casting machines are becoming increasingly stringent. Particularly in application scenarios requiring both high flow rates and high response speeds, only a few direct-drive voice coil motor (VCM) proportional servo valves with high-performance drive components and relatively high costs can meet these stringent requirements. Therefore, for selection of the hydraulic valves in certain special application fields, improving the power limits has become an unavoidable technical challenge.

In the prior art, the power limit of a valve is typically improved by structurally optimizing the controller, the electromechanical converter, and the valve body. The power limit of the valve depends on its driving power and consumed power. The driving power is mainly improved by optimizing the circuit and control algorithm of the controller and changing the driving mode of the electromechanical converter. From the perspective of consumed power, the influence of a flow force is far greater than that of friction, a spring and other factors. Therefore, most research on structural optimization focuses on optimization of the flow force.

To optimize steady-state flow force structures, existing research mainly focuses on optimizing a jet angle through a flow guide structure. The stepped spool, the non-full-opening structure, and the shaft shoulder at an oil inlet are all commonly used for flow guidance. However, the compensation for a negative-feedback flow force upon optimization is not obvious, and the overall negative-feedback flow force remains prominent. Therefore, a spool-sleeve structure capable of generating a positive-feedback flow force has great potential value for the development of the industry.

### SUMMARY

In view of shortages of the prior art, an objective of the present disclosure is to provide a positive-feedback steady-state flow force structure for a spool. The structure is configured to mitigate an original large negative-feedback flow force of outlet jet fluid, thereby improving limiting performance of a valve.

The objective of the present disclosure is achieved by the following technical solutions: The present disclosure provides a positive-feedback steady-state flow force structure for a spool, where the spool cooperates with a sleeve to generate a vortex during movement; and fluid at different flow velocities in a same flow chamber generates different thrusts on a wall of the flow chamber, thereby forming a positive-feedback flow force that facilitates the movement of the spool.

Further, two sets of symmetric frustoconical structures are respectively disposed on two ends of the spool, and a plurality of oil holes corresponding to a frustoconical wall are formed in the sleeve, thereby forming the positive-feedback steady-state flow force structure.

Further, through cooperation between the spool and the sleeve, when the spool opens to a certain extent, flowing oil generates the vortex in the flow chamber defined by the spool and the sleeve, such that a pressure on an outer side of the positive-feedback steady-state flow force structure is greater than a pressure on an inner side of the positive-feedback steady-state flow force structure.

Further, when hydraulic oil returns, in a hydraulic flow chamber defined by the spool and the sleeve, the oil is throttled when flowing through an opening between the sleeve and the spool, such that pressure energy is converted into kinetic energy; the vortex is formed with a non-flowing cross-section of the sleeve, such that flow velocities of oil on two side walls of the flow chamber are different to form a pressure difference; and the oil at different pressures squeezes walls of the spool on two sides of the flow chamber to form the positive-feedback flow force.

Further, the positive-feedback steady-state flow force structure is configured to convert pressure energy of the fluid at an inlet of the flow chamber into kinetic energy, and then convert the kinetic energy into pressure energy of the fluid at an outlet of the flow chamber, thereby generating the positive-feedback flow force that expands a valve port.

Further, the symmetric frustoconical structures on the two ends of the spool are formed by turning or grinding a conventional spool; and the sleeve is obtained by drilling positions of a conventional sleeve corresponding to truncated cones.

Further, a flow velocity of the fluid on a wall is obtained based on a flow rate of the fluid forming the vortex and an area of a frustoconical side; a flow velocity of the fluid acting on a wall of a non-flowing chamber is regarded as zero; and based on a principle of a Bernoulli equation, a relationship between a pressure on the wall of the non-flowing chamber and an input pressure of the valve port is obtained, thereby obtaining a difference between equivalent thrusts on left and right walls of the positive-feedback steady-state flow force structure, namely the positive-feedback flow force.

Further, the positive-feedback flow force changes according to a spool opening, so as to compensate a negative-feedback flow force during the movement of the spool, and reduce a peak flow force.

Further, when the spool is not provided with the positive-feedback steady-state flow force structure, a total flow force of the spool acts as a negative-feedback flow force; and based on the positive-feedback steady-state flow force structure, an absolute value of the total flow force of the spool is reduced, such that a first-order coefficient of a spool displacement is decreased, a motion resistance is reduced, and the spool is pushed more easily.

The present disclosure has the following beneficial effects:
1. The present disclosure designs a vortex generation structure based on the cooperation between the spool and the sleeve, mitigates the problem of the original large negative-feedback flow force of the outlet jet fluid, and improves the power limit of the valve.
2. The present disclosure generates the obvious positive-feedback flow force. Computational fluid dynamics (CFD) simulation shows that the structure can effectively increase the positive-feedback force of the spool. When the spool operates at a low pressure, a low flow rate, and a low power, the compensation effect is not obvious, and the force on the spool is still dominated by a small negative-feedback flow force. When the spool operates in a limiting condition with a high pressure and a high flow rate, the compensation effect is significant, and the force on the spool is a medium positive-feedback flow force. Experiments show that the structure of the present disclosure effectively reduces the resistance characteristics of the negative-feedback flow force and reduces the peak flow force of the outlet jet fluid.
3. The spool provided with the positive-feedback steady-state flow force structure can reduce the resistance characteristics of the flow force, can prevent power saturation of the original structure at steady-state high-pressure and high-flow points, and can allow the spool to operate in a certain combined flow rate-pressure condition, expanding the power limit of the valve to a pressure rating limit of the valve body. The spool provided with the positive-feedback steady-state flow force structure of the present disclosure can solve the problem of frequent dynamic instability of the conventional spool under high pressure difference operating conditions.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show merely some embodiments of the present disclosure, and those skilled in the art may still derive other drawings from these accompanying drawings without creative efforts.

FIG. 1 is a schematic cross-sectional view illustrating that a spool provided with a positive-feedback steady-state flow force structure for a spool is disposed on a valve body;

FIG. 2 is an enlarged view of a structural detail in FIG. 1;

FIG. 3 is a schematic view of a spool provided with a positive-feedback steady-state flow force structure;

FIG. 4 is a schematic view of a sleeve having special holes and matching with the spool in FIG. 3;

FIG. 5 is a schematic diagram of a flow rate when oil flows through a positive-feedback steady-state flow force structure;

FIG. 6 is a schematic view of a hole diameter of a sleeve;

FIG. 7 is a schematic diagram of cross-sectional dimensions of a positive-feedback steady-state flow force structure;

FIG. 8 is a schematic diagram of force analysis of a positive-feedback steady-state flow force structure; and

FIG. 9 is a schematic diagram of equivalent thrusts on walls of a positive-feedback steady-state flow force structure.

In the figures: 1: valve body, 2: return oil chamber, 3: sleeve, 4: spool, 5: supply oil chamber, 6: outlet oil chamber, 8: frustoconical structure, 9: outer side of positive-feedback steady-state flow force structure, 10: inner side of positive-feedback steady-state flow force structure, and 11: oil hole.

### DETAILED DESCRIPTION OF THE EMBODIMENTS

To make the objectives, technical solutions, and advantages of the present disclosure clearer, the present disclosure is further described below with reference to the accompanying drawings and embodiments. It should be understood that the specific embodiments described herein are merely intended to explain the present disclosure but not to limit the present disclosure.

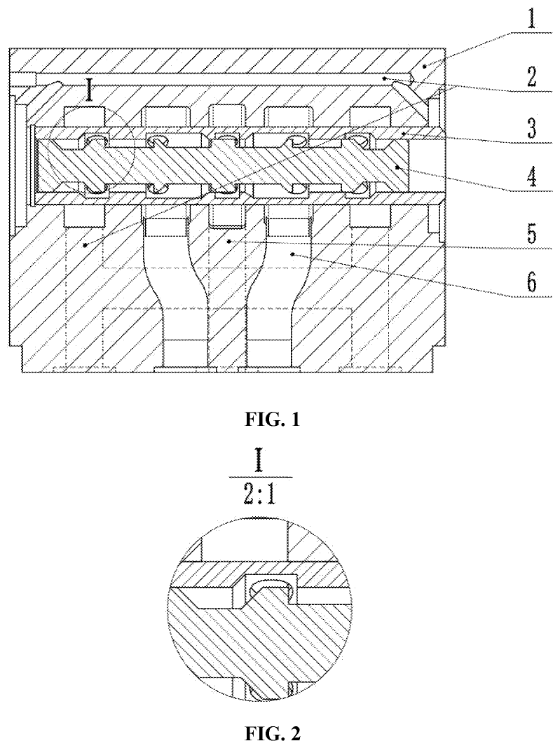

As shown in FIG. 1, the present disclosure provides a positive-feedback steady-state flow force structure for a spool based on cooperation between the spool and a sleeve. The structure is configured to mitigate an original large negative-feedback flow force of outlet jet fluid, thereby improving limiting performance of a valve. The design of a vortex generation structure is inspired by a kinetic energy conversion principle of the Venturi and the diffuser. By optimizing a structure of the spool, the spool forms a “Venturi/diffuser”-like flow field with the sleeve during movement, thereby generating a vortex. Fluid at different flow velocities in a same flow chamber has different pressures, resulting in different thrusts on a wall of the flow chamber to form a thrust (i.e., a positive-feedback flow force) that facilitates the movement of the spool. From energy conversion, pressure energy of the fluid at an inlet of the flow chamber is converted into kinetic energy, and then the kinetic energy is converted into pressure energy of the fluid at an outlet of the flow chamber. That is, the pressure energy converted from the kinetic energy of the outlet jet fluid is utilized to generate the positive-feedback flow force that expands a valve port.

According to a Bernoulli equation, while energy loss is ignored, a pressure of the fluid decreases with an increase of a flow velocity of the fluid. This principle provides theoretical support for generating the positive-feedback steady-state flow force by creating a pressure difference via the vortex to facilitate the movement of the spool.

The Bernoulli equation is as follows:

$$p + \frac{1}{2} ρ {v}^{2} + ρ gh + {ζ}_{w} = C$$

where p is a pressure at a target point in the fluid, ρ is a fluid density, ν is a flow velocity at the target point in the fluid, g is a gravitational acceleration, h is an elevation height at the target point in the fluid, ζ_{w} is energy loss, and C is a constant, and represents total energy of the fluid during flowing.

A specific structure is designed as shown in FIG. 1 and FIG. 2. To generate the positive-feedback thrust, it is critical to form the vortex in a valve chamber of valve body 1. The vortex is formed by means of a non-flowing cross-section of sleeve 3. The principle for forming the vortex is as shown in FIG. 2 that is an enlarged view of the positive-feedback steady-state flow force structure. When the spool 4 operates at a left position (the figure shows the left position, and operation at a right position has the same principle), when hydraulic oil in return oil chamber 2 returns, it flows from a right chamber to a left chamber in a hydraulic flow chamber defined by the spool 4 and the sleeve 3. During this process, the oil is throttled when flowing from the right chamber to the left chamber and flowing through an opening between the sleeve 3 and the spool 4, such that pressure energy of the oil is converted into kinetic energy, and a flow velocity increases. Due to a non-flowing characteristic of the left chamber, the oil forms the vortex herein, such that flow velocities of the oil on left and right walls of the left chamber are different. The oil at the different flow velocities forms a pressure difference in the left chamber. The oil at different pressures squeezes walls of the spool on two sides of the left chamber to form a positive-feedback flow force.

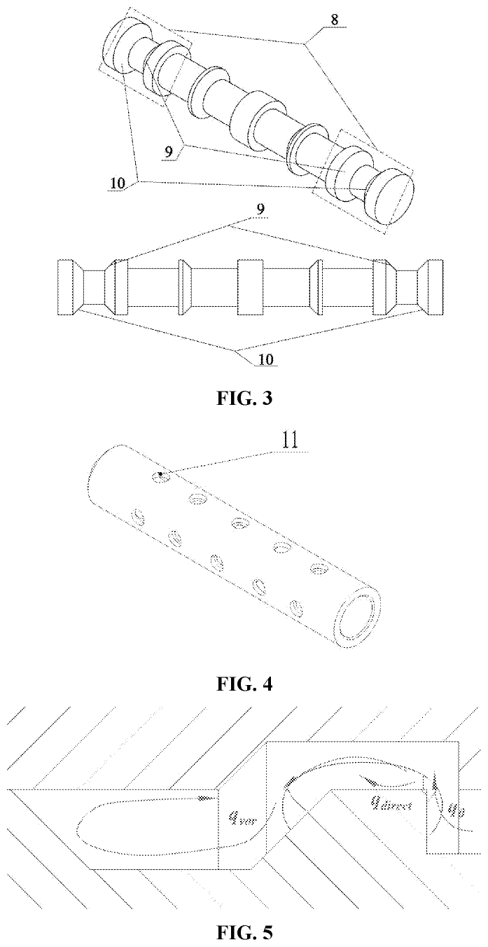

The spool provided with the positive-feedback steady-state flow force structure is specifically as shown in FIG. 3 and FIG. 4. Compared with the spool without the positive-feedback steady-state flow force structure, two sets of symmetric frustoconical structures 8 are respectively disposed on two ends of the spool, twenty oil holes 11 are formed in the basic sleeve, and the oil holes face a frustoconical wall, thereby forming the positive-feedback steady-state flow force structure. After the spool opens to a certain extent through cooperation between the spool 4 and the sleeve 3, the flowing oil forms the vortex in the flow chamber, such that a pressure on outer side 9 of the positive-feedback steady-state flow force structure is greater than a pressure on inner side 10 of the positive-feedback steady-state flow force structure, thereby generating the positive-feedback flow force.

The present disclosure adopts a simple geometric configuration. The spool is machined easily and can be formed only by simple turning or grinding, and the sleeve is obtained by drilling a conventional sleeve. The present disclosure can provide an appropriate positive-feedback flow force according to a spool opening. It significantly compensates a negative-feedback flow force when the spool without the positive-feedback flow force moves, can effectively reduce a peak flow force, and significantly reduces the negative-feedback flow force in the middle stroke section.

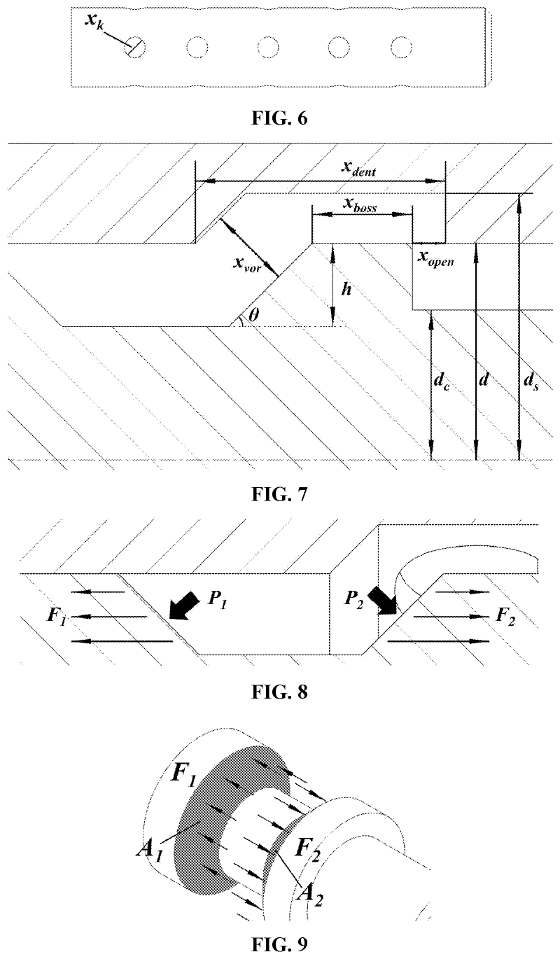

From theoretical analysis, the present disclosure investigates a generation mechanism and influencing factors of the positive-feedback flow force. Taking the positive-feedback steady-state flow force structure as a research object, a mathematical model is established to describe a relationship between the positive-feedback flow force and a basic parameter such as an oil supply pressure, a spool opening, and structural dimensions. The dimensions and the flow rate are as shown in FIG. 5. The flow rate qᵥₒᵣ of the fluid forming the vortex is as follows:

$${q}_{vor} = {q}_{0} - {q}_{direct}$$

where qₒ is an oil supply flow rate of supply oil chamber 5, and q_{direct} is a flow rate of the fluid directly flowing out of outlet oil chamber 6 of the sleeve. The flow rate can be calculated according to a pressure difference at a valve port:

$$q = {C}_{d} {x}_{open} W \sqrt{\frac{2 Δ p}{ρ}}$$

where Δp is the pressure difference at the valve port, C_{d} is a flow coefficient, xₒₚₑₙ is a spool displacement, W is an area gradient, and ρ is a fluid density. W depends on a hole diameter xₖ of the sleeve shown in FIG. 6. The fluid in a region near the outer side of the positive-feedback steady-state flow force structure has a very small flow velocity, and thus this region can be deemed as a non-flowing chamber. A fluid flowing cross-section of the non-flowing chamber is a frustoconical side. As shown in FIG. 7, the generatrix xᵥₒᵣ is as follows:

$${x}_{vor} = ( {x}_{dent} - {x}_{open} - {x}_{boss} ) sin θ$$

where x_{dent} is a total groove length of the sleeve, xₒₚₑₙ is a spool displacement, x_{boss} is a width of a cylindrical surface of a boss of the spool, and θ is an inclination angle of an inclined surface of the boss of the spool. A cross-sectional flow area at an inlet of the non-flowing chamber is area Aᵥₒᵣ of the frustoconical side, and is as follows:

$${A}_{vor} = π {x}_{vor} ( {x}_{vor} cos θ + 2 {d}_{c} + 2 {h}^{′} )$$

where h′ is a height of a point on a right wall of the positive-feedback steady-state flow force structure, and d_{c} is an inner diameter of a corresponding step of the spool.

Fluid on a left wall of the positive-feedback steady-state flow force structure remains almost stationary, with a flow velocity being regarded as v₁=0. A flow velocity of the fluid on the right wall is equivalent to:

$${v}_{2} = \frac{{q}_{vor}}{{A}_{vor}}$$

As shown in FIG. 8 and FIG. 9, since the left flow chamber is the non-flowing chamber, a flow rate of the fluid on surface A₁ is zero, and a pressure of the fluid is set to p₁. Pressure p₂ of the fluid on surface A₂ is derived via the Bernoulli equation:

A relationship between p₁ and input pressure pᵢₙ of the valve port can be obtained based on a flow rate-pressure equation.

Equivalent thrusts on the left and right walls of the positive-feedback steady-state flow force structure are respectively F₁ and F₂. F₂ is a function related to the input pressure pᵢₙ, the oil supply flow rate qₒ, the hole diameter xₖ of the sleeve, the total groove length x_{dent} of the sleeve, the spool displacement xₒₚₑₙ, the width x_{boss} of the cylindrical surface of the boss of the spool, a height h of the boss, a diameter d_{c} of the spool, and the inclination angle θ of the inclined surface of the boss of the spool. It is expressed as follows:

$${F}_{2} = F \{ {p}_{in} , {q}_{o} , {x}_{k} , {x}_{dent} , {x}_{open} , {x}_{boss} , h , {d}_{c} , θ \}$$

The positive-feedback flow force is:

$${F}_{h} = {F}_{1} - {F}_{2}$$

Thus, the positive-feedback flow force can be adjusted by adjusting the input pressure, the flow rate, and the structural parameter.

A resultant force acting on the spool can be expressed as:

$$F = m {\ddot{x}}_{open} + b {\dot{x}}_{open} + {kx}_{open} + {F}_{f}$$

where m is a mass of the spool, b is a damping coefficient, k is a stiffness of the spool, and F_{f} is a total flow force on the spool.

When the spool is not provided with the positive-feedback steady-state flow force structure, F_{f} acts as a negative-feedback flow force. When the positive-feedback flow force is generated, F_{f} is a function positively related to Δp and xₒₚₑₙ. A decrease in an absolute value of F_{f} is equivalent to a decrease of a first-order coefficient k of xₒₚₑₙ, i.e., an equivalent stiffness of the spool is reduced, and its motion resistance is also reduced accordingly, such that the spool is pushed more easily. This improves the driving efficiency of the spool without changing a control current, and raises the power limit of the hydraulic system without compromising normal operation of the spool. Therefore, the present disclosure has a great potential for solving the instability problem under extreme high-pressure limiting conditions.

The above embodiments are intended to explain the present disclosure, rather than to limit the present disclosure. Any modifications and changes made to the present disclosure within the spirit and the protection scope defined by the claims should all fall within the protection scope of the present disclosure.

What is claimed is:

1. A positive-feedback steady-state flow force structure for a spool, wherein two sets of symmetric frustoconical structures are respectively disposed on two ends of the spool, and a plurality of oil holes corresponding to a frustoconical wall are formed in a sleeve, thereby forming the positive-feedback steady-state flow force structure; through cooperation between the spool and the sleeve, when hydraulic oil returns, the spool opens to a certain extent; in a hydraulic flow chamber defined by the spool and the sleeve, fluid on a left wall of the positive-feedback steady-state flow force structure remains almost stationary, and the oil is throttled when flowing through an opening between the sleeve and the spool, such that pressure energy is converted into kinetic energy, forming a “Venturi-and-diffuser-like” flow field; with a non-flowing cross-section of the sleeve, the flowing oil forms a vortex in the flow chamber defined by the spool and the sleeve, such that flow velocities of oil on two side walls of the flow chamber are different to form a pressure difference, and a pressure on an outer side of the positive-feedback steady-state flow force structure is greater than a pressure on an inner side of the positive-feedback steady-state flow force structure; the oil at different pressures squeezes walls of the spool on two sides of the flow chamber to form a positive-feedback flow force; and the positive-feedback flow force facilitates movement of the spool;
the positive-feedback steady-state flow force structure is configured to convert pressure energy of the fluid at an inlet of the flow chamber into kinetic energy, and then convert the kinetic energy into pressure energy of the fluid at an outlet of the flow chamber, thereby generating the positive-feedback flow force that expands a valve port; and
a flow velocity of the fluid on a wall is obtained based on a flow rate of the fluid forming the vortex and an area of a frustoconical side; a wall of a non-flowing chamber is regarded as zero; and based on a principle of a Bernoulli equation, a relationship between a pressure on the wall of the non-flowing chamber and an input pressure of the valve port is obtained, thereby obtaining a difference between equivalent thrusts on left and right walls of the positive-feedback steady-state flow force structure, namely the positive-feedback flow force.

2. The positive-feedback steady-state flow force structure for the spool according to claim 1, wherein the symmetric frustoconical structures on the two ends of the spool are formed by turning or grinding a normal spool; and the sleeve is obtained by drilling positions of a normal sleeve corresponding to truncated cones.

3. The positive-feedback steady-state flow force structure for the spool according to claim 1, wherein the positive-feedback flow force changes according to a spool opening, so as to compensate a negative-feedback flow force during the movement of the spool, and reduce a peak flow force.

4. The positive-feedback steady-state flow force structure for the spool according to claim 1, wherein when the spool is not provided with the positive-feedback steady-state flow force structure, a total flow force of the spool acts as a negative-feedback flow force; and based on the positive-feedback steady-state flow force structure, an absolute value of the total flow force of the spool is reduced, such that a first-order coefficient of a spool displacement is decreased, a motion resistance is reduced, and the spool is pushed more easily.
